(19) United States
(12) Patent Application Publication
(10) Pub. No.: US 2012/0158755 A1
(43) Pub. Date: Jun. 21, 2012

(54) GRANULAR METADATA FOR DIGITAL CONTENT

(75) Inventors: Kevin Gammill, Beaux Arts, WA (US); Stacey Law, Redmond, WA (US); Scott Porter, Sammamish, WA (US); Alex Aben-Athar Kipman, Redmond, WA (US); Avi Bar-Zeev, Redmond, WA (US); Kathryn Stone Perez, Kirkland, WA (US)

(73) Assignee: MICROSOFT CORPORATION, Redmond, WA (US)

(21) Appl. No.: 12/973,643

(22) Filed: Dec. 20, 2010

(51) Int. Cl. G06F 17/30

(52) U.S. Cl. 707/754; 707/E17.044; 707/736

(57) ABSTRACT

Accordingly, the present discussion is directed in one respect; to a method of associating metadata with a digital content item and then controlling the presentation of that item in accordance with metadata-associated controls/constraints. The method may include determining a time-specific portion of a digital content item with which a user desires to associate a metadata item; associating the metadata item with the time-specific portion of the digital content item. During subsequent consumption of the digital content item by the user or another, the metadata item is presented synchronously in co lection with the time-specific portion of the digital content item, where such presentation is constrained or controlled in response to user-controlled filters implemented through a social network.

### BACKGROUND

The Internet houses an ever-growing array of digital content that is consumed by various users in different ways and on different platforms. This content in some cases may be objectionable, or may otherwise motivate a consumer to control how the content is consumed. For example, a parent might wish content to only come on during daytime when children can be observed while watching a television show, for example. The existing controls, however, are crude in their implementation and do not allow for a piece of digital content to be both partly objectionable and partly acceptable, or allow for those assessments to translate into effective and granular control over consumption.

Tags are an often-used mechanism for flagging objectionable or other substance of content, for example categorically tagging items (e.g., tagging video clips as “funny”, “not-work-related,” etc.). The conventional tag mechanism is fairly limited, however, in the sense that the tag information is not very granular. For example, a tag identifying a movie as “depressing” doesn't say much about what aspects or portions of the movie have that characteristic. Solutions that do provide a higher level of granularity are rare, and they commonly involve extensive information. that is difficult to filter and use properly. Also, the information isn't shared effectively amongst user populations who are most likely to be interested in the descriptions provided by the tags/metadata.

### SUMMARY

Accordingly, the present discussion is directed in one respect to a method of associating metadata with a digital content item. The method may include determining a time-specific portion of a digital content item with which user desires to associate a metadata item and associating the metadata item with the time-specific portion of the digital content item. During subsequent consumption of the digital content item by the user or another, the metadata item is presented synchronously in connection with the time-specific portion of the digital content item, where such presentation is constrained or controlled in response to user-controlled filters implemented through a social network.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a system of exemplary computing devices carrying out instructions for processing items in order to associate time-specific metadata which is ultimately used to control or otherwise affect presentation and consumption of digital content items.

FIG. 2 shows an exemplary method for binding tags to time-specific portions of a content item, and then using the tags to control consumption of the content item.

FIG. 3 shows an embodiment of a method for presenting a content item with metadata items selected based on user consumption constraints/controls.

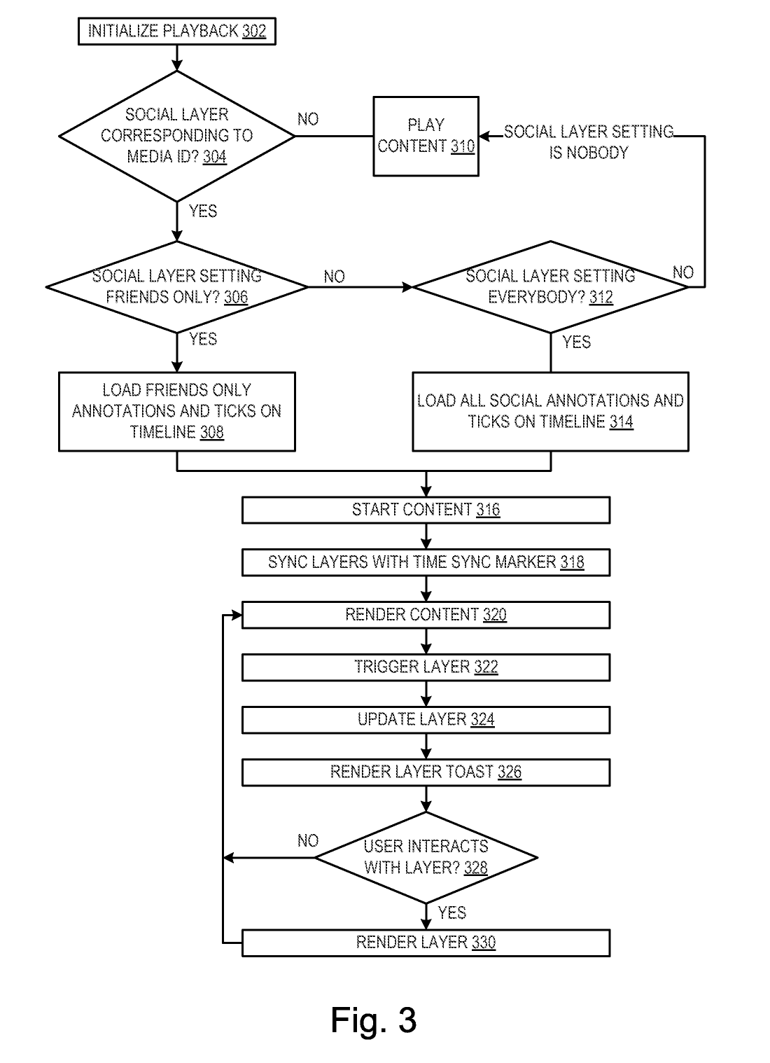

### DETAILED DESCRIPTION

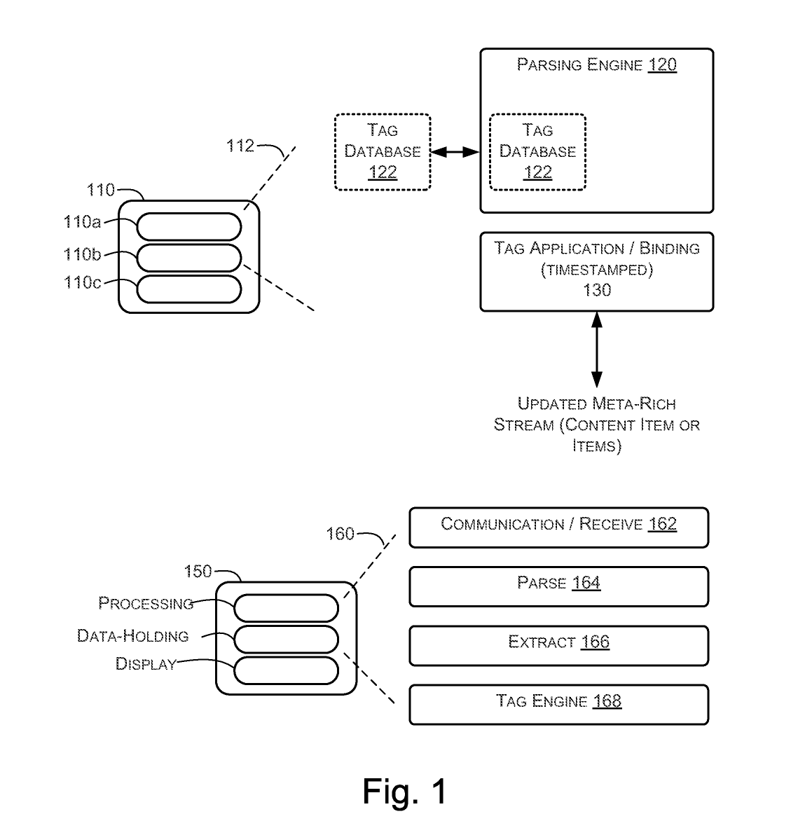

FIG. 1 shows a system 100 for processing digital content items 102, The digital content items may be of any type consumed by users—audio files, videos, movies, still photographs, ebooks and the like, Content items are retrieved through any practicable channel, including through social network recommendations, direct selection, inferred-interest recommendations, etc.

System 100 also includes a processing system carried out through executable instructions, such as instructions 112 executed and instantiated by computing device 110, Computing device 110 is shown as a discrete unit, though it should be understood that multiple distinct devices with multiple different logical and physical domains may be employed. Thus, “modules,” “engines,” processors, “storage devices,” “memory” and the like should be understood as being implementable discretely, in a distributed sense, or otherwise. In addition to distributed implementations, various functions may be housed at and carried out by different unaffiliated actors. It is contemplated that these actors, though independent, will perform their functions with knowledge of the whole system functionality, and thus will be specifically intending that their functionality dovetails with the functionality provided by others.

Example computing device 110 may include various components, such as processing subsystem 110a, data-holding subsystem 110b and display subsystem 110c. Again, this is but an example, and these components may be distributed, distinct, spanned, aggregated or otherwise. The processing subsystem (e.g., including a process) and the data-holding subsystem (e.g., RAM, hard disk storage) typically will perform instructions normally expected of these components, such as storing and executing instructions, such as instructions 112.

Digital content items 102 may be received within and at parsing engine 120 which may interact with tag databases that may be distinctly implemented or in a distributed or other arrangement. For example, the parsing engine 120 may interact with tag databases 122 in various locations.

Downstream of the parsing engine is a tag application engine 130, which specifically binds the tags to a metadata-rich version of a consumable content item. By all appearances, the metadata-rich content item appears exactly as it did before modification, and is consumable through mechanisms that are identical in function and presentation to those used in consumption of the un-modified item.

The metadata-rich version does however, contain a plurality of parsed locations which are denoted with timestamp data, to the extent that such time data is not already inherent and extractable from the content stream. Associated with the time-specific portions is a metadata item, the application of which is controlled by a user in response to substantive portions of the consumed content item. Thus, a timestamped apportion might be tagged with NC-17, R, PG-13 or any other appropriate scheme that registers maturity levels for consumption. Any tag or rating scheme may be applied. Specific portions may be tagged as containing, nudity, vulgarity, etc. Others may be tagged as only being playable when parents are present in the room (e.g., as detected by depth cameras and visions software), These are but a few non-limiting examples.

Content ratings and recommendations may also be generated. through social networks. For example, if a particular portion of a video clip receives a lot of commentary (such as commentary on it being objectionable), then such feedback may be employed to automatically tune and control application of tags to an item. A tag might even simply direct a parental or other supervising user to review the specific portion of the content item to independently judge its acceptability.

Downstream from tag application, the metadata-rich version is updated (140) into the content stream or storage locations, so that subsequent retrievals will pull the modified item.

FIG. 1 shows an additional device 150 that functions as a “tuner” in the sense that the device may seek and permit consumption of a digital content item. As in the other example, processing, data-holding and display functions are present, with the processor carrying out executable instructions that are stored in a data-holding subsystem. Tuners may be employed in device-domain groupings, with one or more devices acting as primary devices, with others acting as secondary devices.

Instructions 160 function to receive (162), the metadata-rich item and parse (164) the stream to extract (166) tags. Then a tag engine 168 matches the tags with a constraining/controlling action to be performed. The tuner device is then controlled so that consumption occurs in accordance with the constraining/controlling actions that are associated with a given tag. The end result is that consumption may he controlled in accordance with metadata-associated controls/constraints, and/or the metadata may be presented synchronously to align with the specific identified portions of the content item. In addition to or instead of control and constraint, metadata, whether implemented particularly through tags or otherwise, may be provided to the user to enhance or supplement the experience of the original material. For example, the metadata item may include an image that is presented synchronously in connection with the time-specific portion of the digital content. As another example, the metadata item may include an audio clip that is presented synchronously in connection with the time-specific portion of the digital content.

Controlling or constraining actions may include skipping over specific timestamped portions of material, playing an alternate filler that is acceptable, providing an opportunity for parents to explain issues arising in a specific portion (e.g., scene from a television show), reducing volume levels, visually blocking objectionable content, etc. These are but non-limiting examples, consumption may be constrained or controlled (or enhanced or supplemented) in a myriad of ways, all of which are at least contemplated in their essence by this disclosure.

Furthermore, in some implementations multiple metadata items may be associated with multiple individual time-specific portions of a digital content item. In such implementations, user-controlled filters may be operable to permit presentation of metadata items only from a selected user population. Further, in such implementations, multiple candidate metadata items may be received from an outside source and the filters may limit presentation of such multiple candidate metadata items so that metadata items from only a selected user population are presented to the user. In some cases, a selected user population may have a group identity with an established affinity to the user consuming the digital content item and filtered metadata items. Moreover, in some cases, the selected user population may be generated in accordance with affinities of individual users with the user.

For example, the above system may be implemented to allow users to share their entertainment experiences with various populations (e.g., their friends) asynchronously by binding metadata items in the form of messages or other information with specific frames of the content item they are playing. Correspondingly, a user can provide filtering parameters to constrain consumption to choose to view comments from their friends. Such a mechanism may allow metadata items such as comments and annotations to be automatically pushed to users' friends by binding the metadata items to content items viewed by the friends. Such enriched content may be distributed through a social network, for example. More particularly, a notification indicating when a metadata item is associated with a digital content item may be generated and issued through the social network to populations associated with the user. Correspondingly, a user may be notified when a piece of content, is annotated by their friend or other populations. Such notifications may be throttled by the user as desired via input to the system. On the other hand, a user can provide filtering parameters to choose to view comments from a larger community. In some cases, a user may provide input to filter out metadata items provided by specific people or specific groups of people. Further still, a user may provide input to turned off presentation of metadata items with associated with a content item.

In some implementations, the above described system may leverage a layer system including social layers. Such social layers may be modular, time-synchronized, event-triggered, multi-formatted, etc. In some implementations, such layers may be presented in a designated user interface (UI) area of the screen or on a companion device. When a user decides to add an annotation to a video, for instance, they may select a UT element that notifies the layer system that the user wishes to add a comment and the system can automatically pause the experience (i.e., presentation of the content item) to allow the user to add metadata items such as text, video, or audio annotations. The metadata item can be stored on the social layer service and pushed down to other viewers of the video. In some implementations, metadata items created by a user may be pushed to friends of the commentator as a default operation, and other populations(e.g., non-friends) may access the content if they explicitly enable viewing of annotations by the larger subscriber community.

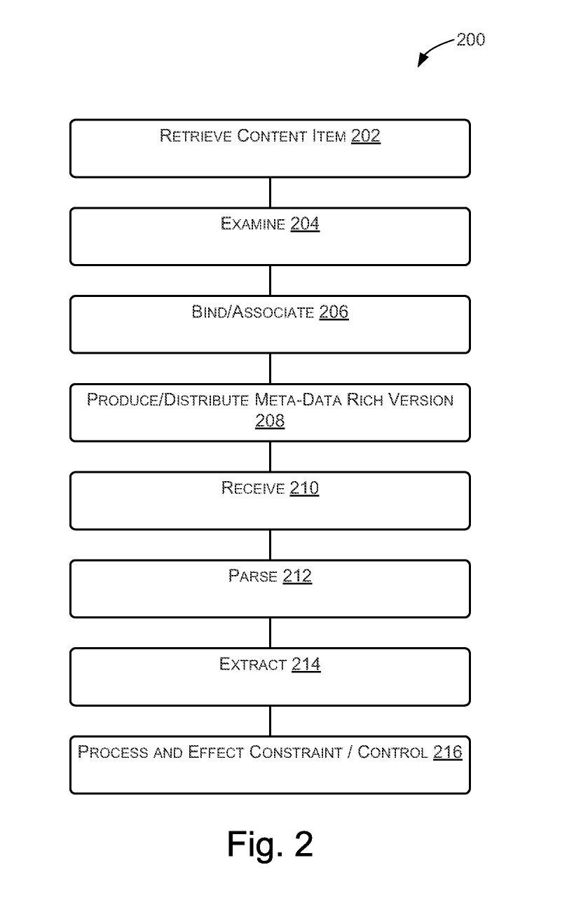

It should thus be apparent that the present description further encompasses various methods of use and manufacture. One exemplary method of use is depicted at 200 in FIG. 2. First, at 202, the method includes retrieving a digital content item. At 204, the content item is examined to identify substance of the content item or other conditions which would warrant control and constraining of content consumption. In this method and in device examples above, examination may not be needed in the event of a third party rating.

At 206, time-specific portions of a content item identified in 204 are linked/bound with an appropriate tag, which as explained above may be present in database storage in various locations.

At 208, an engine or other appropriate mechanism is used to produce a metadata-rich version of the digital content item. In many cases, the meta-data rich version will be distributed through social networks or other appropriate methods of transmission, distribution, updating, etc.

At 210, the metadata-rich version is received, for example at a tuner device. The tuner device may be any type of computer, including smartphone, HDTV, laptop, navigation system or other portable device. In fact, tuners can operate in companion pairs and larger groups. For example, one device (e.g., a smartphone) might be used as an annotating tool that operates while the content is being consumed on a companion device (e.g., a movie playing on an HDTV). Correspondingly, in some implementations, metadata items taking the form of textual annotations may be presented on a companion consumption device synchronously and in conjunction with presentation of the content item on a primary consumption device.

Again, where appropriate, portions of the tuner may be implemented in arrangements other than as discrete computing devices.

At 212, the content stream is parsed. Then the tags are extracted (214), and a tag engine processes the tag and produces a resulting constraint or control (216) over the presentation and consumption of the digital content item.

In the above example methods and systems, a companion device may be used in various ways. As in an example mentioned above, the companion device may be used as an annotation tool to “mark up” a content item as it is being presented. The companion device may also act as a secondary tuner to display metadata while a primary device is presenting the content item. In some implementations, the companion. device may dynamically effect in real-time association of a metadata item with a portion of a digital content item during presentation of the digital content item. Accordingly, a user may enrich a content item with metadata or by performing other constraint and/or control operations during presentation of the content item.

In some implementations, the metadata item may include a correction associated with the digital content item or with other metadata items that are associated with the digital content item. In one example, a user may provide a correction to a content item or metadata item in dynamically real-time during presentation of the content item. Moreover, in some implementations the correction may be provided through a companion device while the content item is presented on a primary device. In implementations that leverage metadata items aggregated from various populations, annotations may be used by the system to collect correction data on information that is provided by the system.

Furthermore, annotations can also be used by administrators of the system to make corrections to data shown to users. For instance, a user may note that a song artist was incorrectly associated to a piece of music. The system may flag this information for a system administrator to verify or the system may allow other subscribers to vote on the accuracy of the information, and the results of which may determine whether the correction is made to the data.

The tag actions associated with specific portions of a content item may include correcting, skipping, replacing, modifying, or any other action to control and constrain consumption, or simply display supplemental/enhanced content along with the original material. The addition of metadata may be implemented by packaging the metadata item into a modular channel that overlays/underlays the stream of content and is available for parallel presentation and consumption with the digital content item.

When user populations are leveraged to generate ratings, tags, recommendations and the like, the user may control the user population upon which such recommendations, ratings, tags, etc, are based, For example, only a selected group of parents may he permitted to impact a rating of certain content, 3 shows an embodiment of a method for presenting a content item and selectively presenting population specific metadata items. At 302, playback of a content item is initialized. At 304, it is determined whether the social layer or channels associated with the digital content item match specific media identification. For example, the media identification may correspond to a user any may link various approved populations to the user as well as previously set consumption control filter settings, if it is determined that the social layer corresponds to a media identification the method moves to 306. Otherwise, the method moves to 310.

At 306, it is determined whether the social layer corresponding to the media ID is set to present metadata items from friends synchronously with presentation of the content item and filter out metadata items from other populations, if it determined that the social. layer is set to present metadata items from friends and filter out metadata items from other populations, the method moves to 308. Otherwise, the method moves to 312.

At 308, metadata items or annotations generated by friends of the user are loaded at corresponding ticks or timestamps on the timeline of the digital content item.

At 310, it is determined that the social layer is set to no population and the digital content item is played without presentation of metadata items.

At 312, it is determined if the social layer is set to present metadata items from some or all populations. If it, determined that the social layer is set to present metadata item from some or all populations, the method moves to 314. Otherwise the method moves to 310.

At 314, metadata items or annotations generated by some or all of the populations are loaded at corresponding ticks or timestamps on the timeline of the digital content item.

At 316, presentation of the content item, enriched with metadata items, is started, More particularly, at 318, the social layer is synchronized with a time synchronization marker of the digital content item. At 320, the digital content is rendered. At 322 the social layer is triggered to synchronously present metadata items at time-specific portions of the digital content item, At 324, the social layer is updated with any metadata items. At 326, the rendered layer is toasted with the content item to provide synchronous presentation of the metadata item. and the content item.

At 328, it is determined whether the user interacts with the social layer. For example, the user may interact with the social layer by providing a metadata item such as an annotation or correction to the content item. As another example, the user may provide input to adjust; consumption constraints/controls of the content item. If it is determined that user interacted with the social layer, the method moves to 330. Otherwise, the method returns to 320 and the content is rendered for presentation.

At 330, the social layer is rendered to include the updated interactions of the user. Upon rendering the updated social layer, the method moves returns to 320 and the digital content item is rendered for presentation to the user with the updated interactions of the user. For example, the digital content item may be rendered to include an annotation generated by the user. As another example, the digital content item may be rendered to adjust presentation based on adjustment of consumption constraints/controls by the user.

As indicated, some embodiments may entail tying the methods to a computing device, which may include a processing subsystem, dataholding subsystem and display subsystem as its primary components. Still further, the methods and processes described herein may be implemented as a computer application, computer service, computer API, computer library, and/or other computer program product.

A processing subsystem in the current examples may include one or more physical devices configured to execute one or more instructions. For example, a processing subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

One or more processors may be employed to execute software instructions. Additionally or alternatively, the one or more hardware or firmware logic machines may be configured to execute hardware or firmware instructions. Processors of the logic subsystem may he single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

The data-holding subsystem may include one or more physical, non-transitory, devices configured to hold data and/or instructions executable by the logic subsystem to implement the herein described methods and processes. When such methods and processes are implemented, the state of data-holding subsystem may be transformed (e.g., to hold different data). The Ddta-holding subsystem may further include removable media and/or built-in devices. Further it may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. The following characteristics may describe data-holding components: volatile, nonvolatile, dynamic, static, read/write, read-only, random access, sequential access, location addressable, file addressable, and content addressable.

The terms “module,” “program,” and “engine” may be used to describe an aspect of computing system that is implemented to perform one or more particular functions. In some cases, such a module, program, or engine may be instantiated via a logic/processing subsystem executing instructions held by a data-holding subsystem. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on a server responsive to a request from a client.

When included, a display subsystem may be used to present a visual representation of data held by the data-holding subsystem. As the herein described methods and processes change the data held by the data holding subsystem, and thus transform the state of the data-holding subsystem, the state of a display subsystem may likewise be transformed to visually represent changes in the underlying data. The display subsystem may include one or more display devices utilizing virtually any type of technology. Such display devices may be combined with the processing subsystem and/or data-holding subsystem in a shared enclosure, or such display devices may be peripheral display devices.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and suhcombinations of the various processes, systems and configurations, and other features, functions, acts, and/or properties disclosed herein, as well as any and all equivalents thereof.

1. A method of associating metadata with a digital content item, comprising:
determining a time-specific portion of a digital content item with which a user desires to associate a metadata item;
associating said metadata item with said time-specific portion of the digital content item; and
during subsequent consumption of the digital content item by the user or another, presenting the metadata item synchronously in connection with the time-specific portion of the digital content item, where such presentation is constrained or controlled in response to user controlled filters implemented through a social network.

2. The method of claim 1, where said associating of the metadata item is effected dynamically in real-time during presentation of the digital content item on a primary device.

3. The method of claim 2, where said associating of the metadata item is effected through use of a companion device that is distinct from the primary device.

4. The method of claim 1, where during the subsequent consumption, the digital content item is presented on a primary consumption device with the metadata item being presented on a companion consumption device.

5. The method of claim 1, where the metadata item is a textual annotation.

6. The method of claim 5, where the metadata item is a correction associated with the digital content item or with other metadata items that are associated with the digital content item.

7. The method of claim 1, where the metadata item is an audio clip.

8. The method of claim 1, where the metadata item is an image.

9. The method of claim 1, where the metadata item is packaged into a modular channel that overlays and is presented along with the digital content item.

10. The method of claim 1, where multiple metadata items are associated with multiple individual time-specific portions of the digital content item, and where the user-controlled filters are operable to permit presentation of metadata items only from a selected user population.

11. The method of claim 10, where the selected user population has a group identity with an established affinity to the user consuming the digital content item and filtered metadata items.

12. The method of claim 10, where the selected user population is generated in accordance with affinities of individual users with the user.

13. The method of claim 1, further comprising generating and issuing a notification to the social network when the metadata item is associated with the digital content item.

14. A method of presenting metadata in conjunction with a digital content item, comprising:
receiving community-generated metadata, where at least some of such community-generated metadata is associated with one or more time-specific portions of a digital content item;
filtering said community-generated metadata with user-controlled. filters that are implemented through a social network; and
coordinating user consumption of the digital content item so that associated community-generated metadata is presented synchronously to a user along with the digital content item.

15. The method of claim 14, where in said coordinating step, the digital content item is presented to the user on a primary consumption device, with the associated community-generated metadata being presented to the user on a companion consumption device.

16. The method of claim 14, where subsequent to said receiving of the community-generated metadata, said community-generated metadata is dynamically associated with said one or more time-specific portions of the digital content item using a companion.

17. A system for associating metadata with and consuming a digital content item, comprising:
a logic subsystem including one or more processors; and
a data-holding subsystem containing instructions executable by the processor to
determine a time-specific portion of a digital content item with which a user desires to associate a metadata item;
associate said metadata item with said time-specific portion of the digital content item; and
during subsequent consumption of the digital content item by the user, present the metadata item synchronously in connection with time-specific portion of the digital content item, where such presentation is controlled by the instructions in response to a user-controlled filter implemented through interaction with a social network.

18. The method of claim 17, where the instructions are further operable to receive multiple candidate metadata items from an outside source, and limit presentation of such multiple candidate metadata items so that metadata items from only a selected user population are presented to the user.

19. The method of claim 17 where the logic subsystem and data-holding subsystem are part of a companion device that may be used to conduct real-time annotation of the digital content item during its presentation on another device.

20. The method of claim 17, where the instructions are further operable to generate and issue a notification to the social network upon association of the metadata item with the time-specific portion of the digital content item.
